(19) United States
(12) Patent Application Publication
(10) Pub. No.: US 2024/0165603 A1
(43) Pub. Date: May 23, 2024

(54) SYSTEM AND METHOD FOR ON-SITE CLEANING AND RESTORATION OF KINETIC PROPERTIES OF ION EXCHANGE RESIN

(71) Applicant: IONX SOLUTIONS, LLC, Glendale, AZ (US)

(72) Inventors: Thomas O. Miller, Peoria, AZ (US); Jared Miller, Peoria, AZ (US)

(21) Appl. No.: 18/552,162

(22) PCT Filed: Mar. 29, 2022
(86) PCT No.: PCT/US2022/022407

§ 371 Date: Sep. 22, 2023

Related U.S. Application Data
(60) Provisional application No. 63/167,638, filed on Mar. 29, 2021.

(51) Int. Cl. B01J 49/60; B01J 49/50; B01J 49/85

(52) U.S. Cl. CPC B01J 49/60; B01J 49/50; B01J 49/85

(57) ABSTRACT

A system and method for on-site cleaning of an ion exchange resin is disclosed. The system includes a mixing tank in fluid communication with a resin vessel, first and second chemical sources, first, second, and third pumps, and a deionized water source. The mixing tank and pumps are mounted on a portable skid. A cleaning solution is made within the mixing tank by displacing oxygen from the tank with a nitrogen blanket, and injecting a sulfite solution, an acid, and deionized water into the mixing tank. The third pump is configured to recirculate and mix the cleaning solution, drawing the cleaning solution from the mixing tank, past an instrument bank, and back into the mixing tank until mixed. The third pump is also configured to inject the cleaning solution into the resin vessel containing the ion exchange resin. The portable system is in fluid communication with a waste sump.

### RELATED APPLICATIONS

This application claims the benefit of U.S. provisional patent application 63/167,638, filed Mar. 29, 2021 titled “System and Method for Restoring Kinetic Properties of Resin In-Place,” the entirety of the disclosure of which is hereby incorporated by this reference.

### TECHNICAL FIELD

Aspects of this document relate generally to the cleansing of ion exchange resins.

### BACKGROUND

It is known that power plants and other industries utilize ion exchange resins to purify water used in producing steam. The rate at which ion exchange occurs at exchange sites on resin is referred to as ion exchange kinetics, and is expressed as the mass transfer coefficient (MTC), or the speed at which an exchange site on a resin bead removes ionic impurities from service water through polar attraction. Excellent resin kinetics implies the resin is able to attract and remove impurities before the water carries them past ion exchange sites, and can be summarized as, “The better the kinetic properties are on resin, the higher the quality of effluent waters it will produce.” Organic materials and iron oxides adhering to the surface of resins can block exchange sites, slowing the ability of the resin to attract and remove impurities. Blocking exchange sites on resin surfaces results in higher levels of impurities remaining in effluent waters.

To control corrosion rates in plant equipment, the power industry elevates the pH of process waters with various organic amines. Organic additives chemically break down in regions of high temperatures. The resulting decomposition products are captured on surfaces of ion exchange resins, causing the resins to become fouled.

It has recently been determined that decomposition products of pH control additives such as Monoethanolamine (ETA/MEA) are captured on resins as both positively and negatively charged anions, resulting in ETA/MEA organic complexes. Current resin regeneration processes are unable to effectively remove anionic ETA, or organic and iron oxide foulants from resin surfaces, rendering anion resins incapable of performing ion exchange. Degraded kinetic properties due to organic fouling, results in increased chloride, sulfate and silica slippage from ion exchangers during service runs. Impurities in industrial feedwaters challenge chemistry goals designed to minimize corrosion. Typically, kinetically fouled resin must be removed from service, discarded, and replaced with new.

Replacing resin charges is extremely costly, and if discarded resin is contaminated with detectible isotopic activity (nuclear power) the cost to bury as radwaste significantly increases replacement costs. Previously, no known acceptably safe or effective method has existed for removing organic fouling and iron oxides from the surface of resin beads.

The increasing demands in the utility sector to lower feedwater impurities as a result of resin maintenance activities are well documented gaps in maintaining health and readiness of condensate polishing resins. Conventional regeneration methods are unable to maintain ion exchange kinetics on polisher resins.

Few solutions to this issue can be found in prior art. For example, sodium bisulfite has been proposed as a solution for removing rust from water softeners, as taught by Hatch (U.S. Pat. No. 3,139,401). Other resin regeneration chemicals have been previously patented for their anion/cation resin separation properties, but the scope of the application as taught by Auerswald (U.S. Pat. No. 4,511,675) is limited.

The cleaning and restoration of kinetic properties in ion exchange media is further complicated by the use of the media in power plants. Servicing the resin off-site may require excessive downtime for the plant. The radiation present at nuclear power plants may further complicate off-site servicing. Servicing the resin on-site faces different obstacles, particularly at nuclear power plants. Transporting liquids, particularly caustic or hazardous liquids, into such a plant raises a number of logistical hurdles such as security at the plant as well as the DOT safety requirements for transporting hazardous material.

### SUMMARY

According to one aspect, a portable system for on-site cleaning of an ion exchange resin includes a mixing tank in fluid communication with a first chemical source through a first pump, a second chemical source through a second pump, a deionized water source through at least one of the first pump and the second pump, a nitrogen source, and a waste sump. The system also includes a first instrument bank in fluid communication with the mixing tank. The first instrument bank is configured to provide a first reading describing a fluid inside the mixing tank. The system includes a third pump in fluidic communication with a resin vessel containing the ion exchange resin. The third pump is coupled to the mixing tank such that the mixing tank is in fluidic communication with itself through the third pump. The mixing tank is in fluidic communication with the resin vessel through the third pump, and the resin vessel is in fluidic communication with itself through the third pump. The system also includes a second instrument bank in fluid communication with the third pump. The second instrument bank is configured to provide a second reading describing an output of the third pump. The system includes a portable skid coupled to at least the mixing tank, the resin vessel, the first pump, the second pump, the third pump, the first instrument bank, and the second instrument bank. The system also includes a programmable logic controller (PLC) coupled to the portable skid and communicatively coupled to the first pump, the second pump, the third pump, a plurality of controllable valves, and a network interface for remote operation. The PLC is configured to automatically displace oxygen from the mixing tank by filling the mixing tank with at least one of nitrogen from the nitrogen source and deionized water from the deionized water source, and create a cleaning solution within the mixing tank by injecting a first chemical, a second chemical, and deionized water into the mixing tank. The first chemical is taken from the first chemical source through a first conduit using the first pump, the second chemical is taken from the second chemical source through a second conduit using the second pump, and the deionized water is taken from the deionized water source by the first pump to flush the first chemical from the first conduit and first pump and by the second pump to flush the second chemical from the second conduit and the second pump. The PLC is also configured to automatically recirculate the cleaning solution using the third pump, drawing the cleaning solution from the mixing tank, past the second instrument bank, and back into the mixing tank, until the first reading from the first instrument bank substantially equals the second reading from the second instrument bank. And inject the cleaning solution into the resin vessel containing the ion exchange resin. The resin vessel includes at least one eductor configured to move the ion exchange resin within the cleaning solution. The portable system is in fluid communication with the waste sump through a waste conduit releasably coupled to the waste sump.

Particular embodiments may comprise one or more of the following features. The resin vessel may include a strainer. The second reading from the second instrument bank may include a turbidity of the output of the third pump. The PLC may be configured to automatically fill the resin vessel with deionized water, and/or pump additional deionized water into the resin vessel while draining deionized water and suspended debris to the waste sump until the turbidity of the second reading is less than a turbidity threshold. The first reading and the second reading may both include at least one of a conductivity and an oxidation-reduction potential. The PLC may be configured to automatically add an amount of cleaning solution from the mixing tank to the resin vessel while removing an equal amount of used cleaning solution from the resin vessel in response to observing a difference between the first reading and the second reading. The amount may be determined automatically based on the difference between the first reading and the second reading. The PLC may be configured to automatically create a neutralizing solution within the mixing tank by mixing a fourth chemical external to the portable skid and obtained using the first pump with deionized water obtained from the deionized water source, and/or neutralize so2 gas formed within the resin vessel by gradually replacing the cleaning solution within the resin vessel with the neutralizing solution by adding neutralizing solution while gradually draining the resin vessel to the waste sump and recirculating the cleaning solution and neutralizing solution within the resin vessel using the third pump. The PLC may be further configured to regenerate the ion exchange resin after removing the cleaning solution from the resin vessel. The regeneration may be performed using a third chemical external to the portable skid and obtained using the first pump. The at least one eductor may move the ion exchange resin entirely within the resin vessel. The resin vessel may include a bottom having a plurality of eductors. The resin vessel may include a plenum. The at least one eductor is positioned to propel the ion exchange resin from a bottom of the resin vessel, up the plenum, and out a top of the plenum, to settle back down to the bottom of the resin vessel. The at least one eductor may propel the ion exchange resin along a pathway that is outside the resin vessel. The pathway may be a helical pathway, and the resin vessel may be in fluid communication with itself through the helical pathway. The first chemical may be a sulfite solution, and the second chemical may be an acid. The first reading may include a pH, an oxidation-reduction potential, a conductivity, and/or a temperature. The first conduit and the second conduit may both be flexible hoses. Each of the first pump, the second pump, and the third pump may be in fluid communication with a different flow totalizer. The first chemical source may be a chemical tote. The first conduit may be configured to interface with the chemical tote. The second chemical source may be a fifty-five gallon drum. The second conduit may be configured to interface with the fifty-five gallon drum.

According to another aspect of the disclosure, a portable system for on-site cleaning of an ion exchange resin includes a mixing tank in fluid communication with a first chemical source through a first pump, a second chemical source through a second pump, a deionized water source through at least one of the first pump and the second pump, a nitrogen source, and a waste sump. The system includes a first instrument bank in fluid communication with the mixing tank. The first instrument bank is configured to provide a first reading describing a fluid inside the mixing tank. The system includes a third pump in fluidic communication with a resin vessel containing the ion exchange resin. The third pump is coupled to the mixing tank such that the mixing tank is in fluidic communication with itself through the third pump and the mixing tank is in fluidic communication with the resin vessel through the third pump. The system also includes a second instrument bank in fluid communication with the third pump. The second instrument bank is configured to provide a second reading describing an output of the third pump. The system includes a portable skid coupled to at least the mixing tank, the first pump, the second pump, the third pump, the first instrument bank, and the second instrument bank. The system also includes a programmable logic controller (PLC) coupled to the portable skid and communicatively coupled to the first pump, the second pump, the third pump, and a plurality of controllable valves. The PLC is configured to automatically displace oxygen from the mixing tank by filling the mixing tank with at least one of nitrogen from the nitrogen source and deionized water from the deionized water source. The PLC is also configured to create a cleaning solution within the mixing tank by injecting a first chemical, a second chemical, and deionized water into the mixing tank, the first chemical taken from the first chemical source through a first conduit using the first pump, the second chemical taken from the second chemical source through a second conduit using the second pump, and the deionized water taken from the deionized water source by the first pump to flush the first chemical from the first conduit and first pump and by the second pump to flush the second chemical from the second conduit and the second pump. The PLC is configured to recirculate the cleaning solution using the third pump, drawing the cleaning solution from the mixing tank, past the second instrument bank, and back into the mixing tank, and inject the cleaning solution into the resin vessel containing the ion exchange resin. The first chemical is a sulfite solution, and the second chemical is an acid. The portable system is in fluid communication with the waste sump through a waste conduit releasably coupled to the waste sump.

Particular embodiments may comprise one or more of the following features. The resin vessel may be located away from the portable skid, and may be in fluid communication with the portable system through a third conduit releasably coupled to the third pump. The resin vessel may also be in fluid communication with the portable system through a fourth conduit releasably coupled to the third pump. The cleaning solution may be recirculated within the resin vessel, being sent to the resin vessel by the third pump through the third conduit and taken from the vessel by the third pump through the fourth conduit. The first reading and the second reading may both include at least one of a conductivity and an oxidation-reduction potential. The PLC may be configured to automatically add an amount of cleaning solution from the mixing tank to the resin vessel while removing an equal amount of used cleaning solution from the resin vessel in response to observing a difference between the first reading and the second reading. The amount may be determined automatically based on the difference between the first reading and the second reading. After the cleaning solution has operated on the ion exchange resin within the resin vessel, the cleaning solution may be sent directly to the waste sump from the resin vessel. The portable system may also include the resin vessel, the resin vessel being coupled to the portable skid and in fluid communication with itself through the third pump. The PLC may be further configured to automatically recirculate the cleaning solution through the resin vessel with the third pump. The resin vessel may include a strainer. The second reading from the second instrument bank may include a turbidity of the output of the third pump. The PLC may be configured to automatically fill the resin vessel with deionized water, and/or pump additional deionized water into the resin vessel while draining deionized water and suspended debris to the waste sump until the turbidity of the second reading is less than a turbidity threshold. The first reading and the second reading may both include at least one of a conductivity and an oxidation-reduction potential. The PLC may be configured to automatically add an amount of cleaning solution from the mixing tank to the resin vessel while removing an equal amount of used cleaning solution from the resin vessel in response to observing a difference between the first reading and the second reading. The amount may be determined automatically based on the difference between the first reading and the second reading. The PLC may be further configured to regenerate the ion exchange resin after removing the cleaning solution from the resin vessel. The regeneration may be performed using a third chemical external to the portable skid and obtained using the first pump. The PLC may be configured to automatically create a neutralizing solution within the mixing tank by mixing a fourth chemical external to the portable skid and obtained using the first pump with deionized water obtained from the deionized water source, and/or neutralize so2 gas formed within the resin vessel by gradually replacing the cleaning solution within the resin vessel with the neutralizing solution by adding neutralizing solution while gradually draining the resin vessel to the waste sump and recirculating the cleaning solution and neutralizing solution within the resin vessel using the third pump. The resin vessel may include at least one eductor configured to move the ion exchange resin within the cleaning solution. The at least one eductor may move the ion exchange resin entirely within the resin vessel. The resin vessel may include a bottom having a plurality of eductors. The resin vessel may include a plenum. The at least one eductor may be positioned to propel the ion exchange resin from a bottom of the resin vessel, up the plenum, and out a top of the plenum, to settle back down to the bottom of the resin vessel. The at least one eductor may propel the ion exchange resin along a pathway that is outside the resin vessel. The pathway may be a helical pathway, and the resin vessel may be in fluid communication with itself through the helical pathway. The portable skid may be sized and shaped for transport with a vehicle. The first reading may include a pH, an oxidation-reduction potential, a conductivity, and/or a temperature. The first conduit and the second conduit may both be flexible hoses. Each of the first pump, the second pump, and the third pump may be in fluid communication with a different flow totalizer. The first chemical source may be a chemical tote. The first conduit may be configured to interface with the chemical tote. The second chemical source may be a fifty-five gallon drum. The second conduit may be configured to interface with the fifty-five gallon drum.

According to yet another aspect of the disclosure, a portable system for on-site cleaning of an ion exchange resin includes a mixing tank in fluid communication with a first chemical source through a first pump, a second chemical source through a second pump, a deionized water source through at least one of the first pump and the second pump, a nitrogen source, and a waste sump. The system includes a first instrument bank in fluid communication with the mixing tank. The first instrument bank is configured to provide a first reading describing a fluid inside the mixing tank. The system includes a third pump in fluidic communication with a resin vessel containing the ion exchange resin. The third pump is coupled to the mixing tank such that the mixing tank is in fluidic communication with itself through the third pump and the mixing tank is in fluidic communication with the resin vessel through the third pump. The system includes a second instrument bank in fluid communication with the third pump. The second instrument bank is configured to provide a second reading describing an output of the third pump. The system includes a portable skid coupled to the mixing tank, the first pump, the second pump, the third pump, the first instrument bank, and the second instrument bank. A cleaning solution is made within the mixing tank by displacing oxygen from the mixing tank by filling the mixing tank with at least one of nitrogen from the nitrogen source and deionized water from the deionized water source, and injecting a first chemical, a second chemical, and deionized water into the mixing tank. The first chemical is taken from the first chemical source through a first conduit using the first pump, the second chemical is taken from the second chemical source through a second conduit using the second pump, and the deionized water is taken from the deionized water source by at least one of the first pump and the second pump. The third pump is configured to recirculate and mix the cleaning solution, drawing the cleaning solution from the mixing tank, past the second instrument bank, and back into the mixing tank. The third pump is also configured to inject the cleaning solution into the resin vessel containing the ion exchange resin. The portable system is in fluid communication with the waste sump through a waste conduit releasably coupled to the waste sump.

Particular embodiments may comprise one or more of the following features. The resin vessel may be located away from the portable skid, and may be in fluid communication with the portable system through a third conduit releasably coupled to the third pump. The resin vessel may also be in fluid communication with the portable system through a fourth conduit releasably coupled to the third pump. The cleaning solution may be recirculated within the resin vessel, being sent to the resin vessel by the third pump through the third conduit and taken from the vessel by the third pump through the fourth conduit. After the cleaning solution has operated on the ion exchange resin within the resin vessel, the cleaning solution may be sent directly to the waste sump from the resin vessel. The portable system may further include a programmable logic controller (PLC) coupled to the portable skid and communicatively coupled to the first pump, the second pump, the third pump, and a plurality of controllable valves. The PLC may be configured to automatically displace oxygen from the mixing tank by filling the mixing tank with at least one of nitrogen from the nitrogen source and deionized water from the deionized water source, automatically create the cleaning solution within the mixing tank by injecting the first chemical, the second chemical, and deionized water into the mixing tank, the first chemical taken from the first chemical source through the first conduit using the first pump, the second chemical taken from the second chemical source through the second conduit using the second pump, and the deionized water taken from the deionized water source by the first pump to flush the first chemical from the first conduit and first pump and by the second pump to flush the second chemical from the second conduit and the second pump, automatically recirculate the cleaning solution using the third pump, drawing the cleaning solution from the mixing tank, past the second instrument bank, and back into the mixing tank until the first reading from the first instrument bank substantially equals the second reading from the second instrument bank, and/or automatically inject the cleaning solution into the resin vessel containing the ion exchange resin. The portable system may further include the resin vessel. The resin vessel may be coupled to the portable skid and may be in fluid communication with itself through the third pump. The PLC may be further configured to automatically recirculate the cleaning solution through the resin vessel with the third pump. The resin vessel may include a strainer. The second reading from the second instrument bank may include a turbidity of the output of the third pump. The PLC may be configured to automatically fill the resin vessel with deionized water, and/or pump additional deionized water into the resin vessel while draining deionized water and suspended debris to the waste sump until the turbidity of the second reading is less than a turbidity threshold. The first reading and the second reading may both include at least one of a conductivity and an oxidation-reduction potential. The PLC may be configured to automatically add an amount of cleaning solution from the mixing tank to the resin vessel while removing an equal amount of used cleaning solution from the resin vessel in response to observing a difference between the first reading and the second reading, the amount may be determined automatically based on the difference between the first reading and the second reading. The PLC may be further configured to regenerate the ion exchange resin after removing the cleaning solution from the resin vessel. The regeneration may be performed using a third chemical external to the portable skid and obtained using the first pump. The PLC may be configured to automatically create a neutralizing solution within the mixing tank by mixing a fourth chemical external to the portable skid and obtained using the first pump with deionized water obtained from the deionized water source, and/or neutralize so2 gas formed within the resin vessel by gradually replacing the cleaning solution within the resin vessel with the neutralizing solution by adding neutralizing solution while gradually draining the resin vessel to the waste sump and recirculating the cleaning solution and neutralizing solution within the resin vessel using the third pump. The portable system may further include the resin vessel. The resin vessel may be coupled to the portable skid and in fluid communication with itself through the third pump. The resin vessel may include at least one eductor configured to move the ion exchange resin within the cleaning solution. The at least one eductor may move the ion exchange resin entirely within the resin vessel. The resin vessel may include a bottom having a plurality of eductors. The resin vessel may include a plenum. The at least one eductor may be positioned to propel the ion exchange resin from a bottom of the resin vessel, up the plenum, and out a top of the plenum, to settle back down to the bottom of the resin vessel. The at least one eductor may propel the ion exchange resin along a pathway that is outside the resin vessel. The pathway may be a helical pathway, and the resin vessel may be in fluid communication with itself through the helical pathway. The first chemical may be a sulfite solution, and the second chemical may be an acid. The portable skid may be sized and shaped for transport with a vehicle. The first reading may include a pH, an oxidation-reduction potential, a conductivity, and/or a temperature. The first conduit and the second conduit may both be flexible hoses. Each of the first pump, the second pump, and the third pump may be in fluid communication with a different flow totalizer. The first chemical source may be a chemical tote. The first conduit may be configured to interface with the chemical tote. The second chemical source may be a fifty-five gallon drum. The second conduit may be configured to interface with the fifty-five gallon drum.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112(f). Thus, the use of the words “function,” “means” or “step” in the Detailed Description or Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112(f). Moreover, even if the provisions of 35 U.S.C. § 112(f) are invoked to define the claimed aspects, it is intended that these aspects not be limited only to the specific structure, material or acts that are described in the preferred embodiments, but in addition, include any and all structures, materials or acts that perform the claimed function as described in alternative embodiments or forms of the disclosure, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

The disclosure will hereinafter be described in conjunction with the appended drawings, where like designations denote like elements, and:

FIGS. 1A-1C are schematic views of portable systems for on-site cleaning of ion exchange resins;

FIGS. 2A-2D are schematic views of the portable system of FIG. 1A showing various stages of a method for the on-site cleaning of ion exchange resins;

FIGS. 3A and 3B are side and top views of a resin vessel having a plurality of eductors;

FIG. 4 is a side view of a resin vessel having a plenum;

FIGS. 5A and 5B are side and top views of a resin vessel having an external scrubber module; and

FIG. 5C is a cross-sectional view of the scrubber module of FIGS. 5A and 5B.

### DETAILED DESCRIPTION

This disclosure, its aspects and implementations, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspect of the disclosed concepts to the embodiments illustrated.

It is known that power plants and other industries utilize ion exchange resins to purify water used in producing steam. The rate at which ion exchange occurs at exchange sites on resin is referred to as ion exchange kinetics, and is expressed as the mass transfer coefficient (MTC), or the speed at which an exchange site on a resin bead removes ionic impurities from service water through polar attraction. Excellent resin kinetics implies the resin is able to attract and remove impurities before the water carries them past ion exchange sites, and can be summarized as, “The better the kinetic properties are on resin, the higher the quality of effluent waters it will produce.” Organic materials and iron oxides adhering to the surface of resins can block exchange sites, slowing the ability of the resin to attract and remove impurities. Blocking exchange sites on resin surfaces results in higher levels of impurities remaining in effluent waters.

To control corrosion rates in plant equipment, the power industry elevates the pH of process waters with various organic amines. Organic additives chemically break down in regions of high temperatures. The resulting decomposition products are captured on surfaces of ion exchange resins, causing the resins to become fouled.

It has recently been determined that decomposition products of pH control additives such as Monoethanolamine (ETA/MEA) are captured on resins as both positively and negatively charged anions, resulting in ETA/MEA organic complexes. Current resin regeneration processes are unable to effectively remove anionic ETA, or organic and iron oxide foulants from resin surfaces, rendering anion resins incapable of performing ion exchange. Degraded kinetic properties due to organic fouling, results in increased chloride, sulfate and silica slippage from ion exchangers during service runs. Impurities in industrial feedwaters challenge chemistry goals designed to minimize corrosion. Typically, kinetically fouled resin must be removed from service, discarded, and replaced with new.

Replacing resin charges is extremely costly, and if discarded resin is contaminated with detectible isotopic activity (nuclear power) the cost to bury as radwaste significantly increases replacement costs. Previously, no known acceptably safe or effective method has existed for removing organic fouling and iron oxides from the surface of resin beads.

The increasing demands in the utility sector to lower feedwater impurities as a result of resin maintenance activities are well documented gaps in maintaining health and readiness of condensate polishing resins. Conventional regeneration methods are unable to maintain ion exchange kinetics on polisher resins.

Few solutions to this issue can be found in prior art. For example, sodium bisulfite has been proposed as a solution for removing rust from water softeners, as taught by Hatch (U.S. Pat. No. 3,139,401). Other resin regeneration chemicals have been previously patented for their anion/cation resin separation properties, but the scope of the application as taught by Auerswald (U.S. Pat. No. 4,511,675) is limited.

The cleaning and restoration of kinetic properties in ion exchange media is further complicated by the use of the media in power plants. Servicing the resin off-site may require excessive downtime for the plant. The radiation present at nuclear power plants may further complicate off-site servicing. Servicing the resin on-site faces different obstacles, particularly at nuclear power plants. Transporting liquids, particularly caustic or hazardous liquids, into such a plant raises several logistical hurdles such as security at the plant as well as the DOT safety requirements for transporting hazardous material.

Contemplated herein is a portable system for on-site cleaning and restoration of kinetic properties of an ion exchange resin or other media (hereinafter “portable system for on-site cleaning” or “portable system”). Specifically, the contemplated system and method permits the cleaning of impurities from ion exchange resins without removing the resins from their site of use and, in some embodiments, while the resins are in-place. Because the resin does not need to be removed from the site, it may be put back in optimal condition quickly. Additionally, the system and method contemplated herein is able to integrate with existing systems, including existing material procurement procedures, further reducing the disruption associated with servicing the resin.

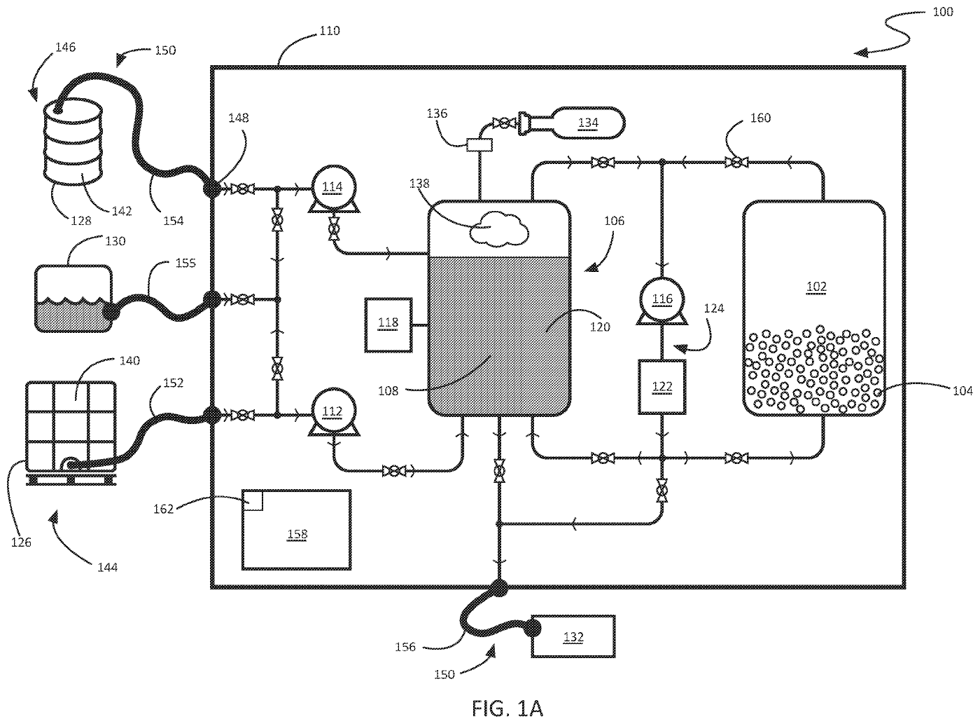

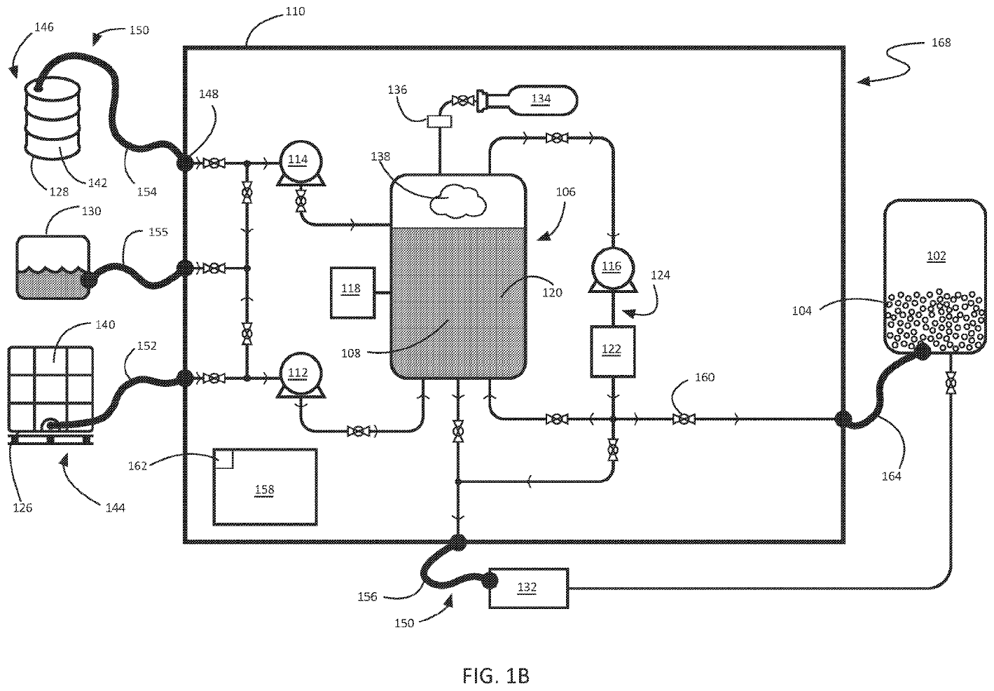

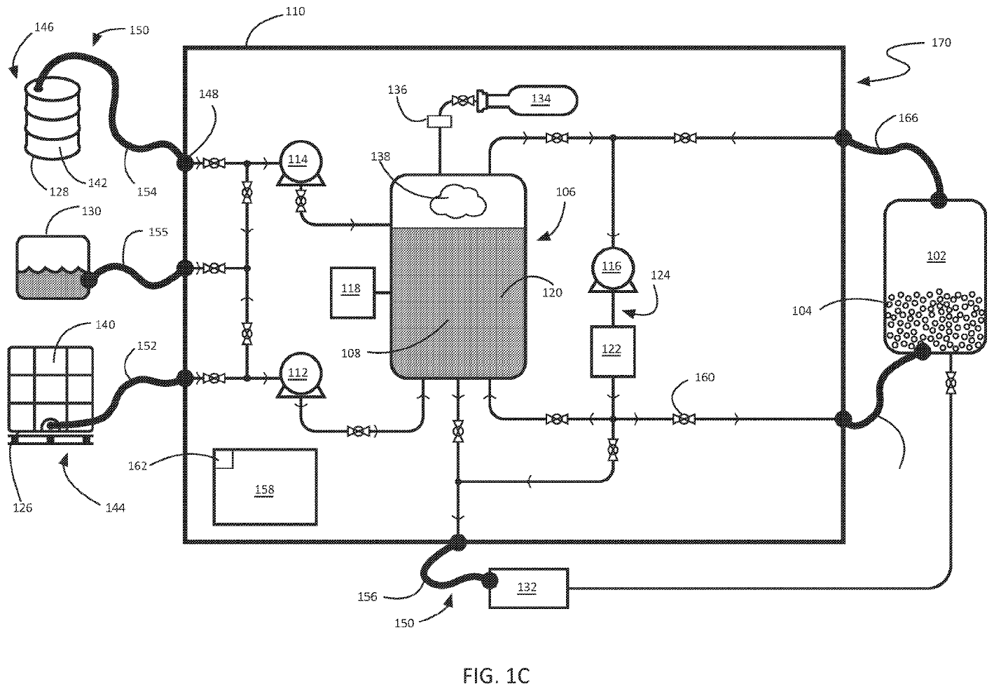

FIGS. 1A-1C are schematic views of non-limiting examples of different embodiments of a portable system for on-site cleaning. Specifically, FIG. 1A is a schematic view of a non-limiting example of a portable system where the ion exchange resin is cleansed within a resin vessel that is part of the portable system, while FIGS. 1B and 1C are schematic views of non-limiting examples of portable systems where the ion exchange resin is cleansed within a resin vessel that is not part of the portable system, but is instead part of the power plant to which the portable system has been transported.

FIG. 1A is a schematic view of a non-limiting example of a portable system 100 having a specialized resin vessel 102 that holds the ion exchange resin 104 being cleaned. As shown, the portable system comprises a mixing tank 106 in fluid communication with a first chemical source 126 through a first pump 112, a second chemical source 128 through a second pump 114, and a deionized water source 130 through at least one of the first pump 112 and the second pump 114. The mixing tank 106 is also in fluid communication with the resin vessel 102 through a third pump 116. Additionally, the mixing tank 106 is in fluid communication with a nitrogen source 134 and a waste sump 132. Each of these elements will be discussed, in turn, below.

In the context of the present description and the claims that follow, a mixing tank 106 is a container within which various fluids 120 may be mixed and/or staged for use elsewhere. These fluids 120 include, but are not limited to, a cleaning solution 108 for the cleaning and restoration of kinetic properties of ion exchange resins 104. According to various embodiments, the mixing tank 106 may be composed of materials compatible with the various fluids 120 it may hold, some of which may be caustic. Exemplary materials include, but are not limited to, 316 stainless steel.

In some embodiments, the mixing tank 106 may be sized to balance the efficiency of having a large amount of cleaning solution 108 prepared and ready for use against the potential waste of preparing solution 108 that is ultimately not needed. In other embodiments, the mixing tank 106 may be sized to provide the greatest utility while still allowing the portable system 100 to fit on a portable skid 110 of a desired size and shape. In some embodiments, the mixing tank 106 may be roughly 5 to 6 feet in diameter, and 3 to 4.5 feet in height, having a dish top and bottom. In other embodiments, the mixing tank 106 may have a volume of 650 gallons. As an option, the mixing tank 106 may further comprise a vacuum breaker and a pressure safety valve, as is known in the art.

The mixing tank 106 is used to create and stage the cleaning solution 108 by combining a first chemical 140 with a second chemical 142. According to various embodiments, the cleaning solution 108 is a catalyzed (or protonated) sulfite solution that is created by combining a sulfite solution (i.e., the first chemical 140) with an acid (i.e., the second chemical 142). The cleaning solution 108 performs a reduction reaction, converting to sulfate as resin 104 is cleaned before regeneration. Combining the component chemicals in the mixing tank 106, rather than introducing them directly to the resin vessel 102, allows for a greater degree of control of the concentrations, and facilitates the reduction of wasted time and solution.

Ion-exchange-inhibiting material that covers or is attached to ion exchange surfaces on resins 104 inhibits charge attraction reactions by interfering with needed contact times required for ionic material exchange, whether it be anionic or cationic. Removing metal oxides, suspended iron oxides, organic materials, crud and other ion exchange impairing media from ion exchange resins 104, membranes (e.g., reverse osmosis membranes, etc.) and other water treatment media can be achieved with application of aggressive sulfite solutions, such as the cleaning solution 108 mixed within the portable system 100. Mixtures containing sulfite solutions catalyzed with protonation donor acids will seek out oxide materials having multiple oxygen molecules available to combine, leaving the metal ions in solution. As the sulfite/catalyst solution protonates iron oxides, the sulfite is converted to sulfate, altering the pH, conductivity, and density of the cleaning solution 108.

Catalyzing sulfite solutions 212 with certain acids provides protonation capability, facilitating the dissolution of metal oxides. Additionally, reducing the solution pH to less than 4.0 allows organics that are normally immune to the effects of brine solutions to be broken into conjugant base chains. Breaking long-chain organic materials having zero electric charge into short-chains results in the short-chain organic molecules each having an electric charge, making them subject to the effects of regenerants and ionized solutions.

As shown, the portable system comprises a first pump 112 (e.g., a chemical transfer pump), a second pump 114 (e.g., an acid transfer pump) and a third pump 116 (e.g., a recirculation/transfer pump). According to various embodiments, these pumps may be any pumping device configured to move solutions and are each adapted for use with a particular fluid or collection of fluids. For example, the second pump 114 is able to withstand the introduction of an acid, such as sulfuric acid, at concentrations which will be discussed further, below.

The first pump 112 and second pump 114 stand between the mixing tank 106 and various sources of fluid (i.e., a first chemical source 126, a second chemical source 128, a deionized water source 130) that are external to the system and not transported to the work site with the portable skid 110, as will be discussed below. According to various embodiments, the third pump 116 is in fluidic communication with the resin vessel 102 containing the ion exchange resin 104, as well as the mixing tank 106. The third pump 116 is coupled to the mixing tank 106 such that the mixing tank 106 is in fluidic communication with itself through the third pump 116, allowing fluid 120 within the mixing tank 106 to be recirculated through the third pump 116. In some (but not all) embodiments, recirculation of fluid through the resin vessel 102 is also accomplished using the third pump 116.

These pumps may have various capacities, according to various embodiments. In a specific embodiment, the pumps may be electric pumps operating at 220V. The first pump 112 may be able to pump at 50 gpm, the second pump 114 at 10 gpm, and the third pump at 100 gpm. In other embodiments, one or more of the pumps may have different capacities. In some embodiments, the pumps may be manually operated, while in others the pumps may be configured for automatic control by a programmable logic controller (PLC) 158 or other similar device.

In the context of the present description and the claims that follow, a resin vessel 102 is a container that holds the ion exchange resin 104 while it is being cleaned by the portable system 100 contemplated herein. In some embodiments, including the non-limiting example shown in FIG. 1A, the resin vessel 102 may be coupled to the portable skid 110 and fully integrated with the rest of the elements of the system. In other embodiments, including the non-limiting examples shown in FIGS. 1B and 1C, the resin vessel 102 may be the container holding the resin 102 in the context of its typical application (e.g., as part of a power plant, etc.). Each of these configurations has advantages and disadvantages, which will be discussed below. The resin vessel 102 is in fluidic communication with the mixing tank 106 through the third pump 116, whether it be through a fixed coupling with the third pump 116 in embodiments where the resin vessel 102 is coupled to the portable skid 110, or through a releasable coupling with the third pump 116 in embodiments where the resin vessel 102 is separate from the portable skid 110 (e.g., resin vessel 102 is part of a power plant, etc.).

The resin vessel 102 contains the ion exchange resin 104. It should be noted that in some embodiments, the ion exchange resin 104 may be an anionic resin, and in other embodiments may be a cationic resin. In still other embodiments, the ion exchange resin 104 inside the resin vessel 102 during the cleaning process contemplated herein may be a mixture of anionic and cationic resins. According to various embodiments, the same cleansing process may be used on both anionic and cationic resins, although in embodiments where the system 100 also performs the regeneration of the resin, the anionic and cationic resins are separated before being exposed to different regeneration materials.

The systems and methods contemplated herein may be used to clean and restore the kinetic properties of various types of ion exchange resins. Examples include, but are not limited to, gel resins and macroreticular or macroporous resins. As previously discussed, the resin 104 within the resin vessel 102 may be anionic, cationic, or both, according to various embodiments. In a specific embodiment, the contemplated system may implement the contemplated method on a resin sample ranging in volume between 25 cubic feet and 350 cubic feet. In other embodiments, different amounts of resin may be cleaned by the contemplated system, in a single implementation of the contemplated method.

As shown, the mixing tank 106 is also in fluid communication with a nitrogen source 134 through a nitrogen regulator 136, according to various embodiments. As discussed above, the cleaning solution 108 cleanses the resin 104 by protonating various oxides that inhibit charge attraction reactions. In some embodiments, the cleaning solution 108 comprises a sulfite compound that is converted to sulfate as the cleansing proceeds. Exposure to oxygen would also convert the sulfite to sulfate, making it ineffective for cleaning. Thus, in some embodiments, the oxygen may be displaced from the mixing tank 106, or at least separated from the sulfite-containing fluid, using a nitrogen blanket 138 created using this nitrogen source 134. In some embodiments, the nitrogen regulator 136 may be electric, and controllable by a PLC 158 or similar device.

According to various embodiments, the system 100 contemplated herein is designed to be portable, able to be transported to the site of a resin vessel 102, such as a nuclear power plant, and temporarily integrated with the existing resin system, and/or simply make use of materials sourced using established procurement methods and sources for that particular site. In some embodiments, the system 100 may be mounted to a portable skid 110. In the context of the present description and the claims that follow, a portable skid 110 is a palate or other rigid transport structure or substrate on which the rest of the system 100 may be mounted and which facilitates the movement of the portable system 100. In some embodiments, the skid 110 may have wheels allowing the skid 110 to be rolled into place. In some embodiments, the portable skid 110 may be sized and shaped to be transported by a vehicle (e.g., forklift, crane, pickup truck, van, trailer, semi-trailer, etc.). Once delivered on-site, the skid 110 may be relocated so it may be attached to the on-site systems (e.g., first chemical source 126, second chemical source 128, deionized water source 130, resin vessel 102, etc.).

According to various embodiments, the portable skid 110 is coupled to at least the mixing tank 106, the first pump 112, the second pump 114, the third pump 116, the first instrument bank 118, and the first instrument bank 122. In some embodiments, the skid 110 also holds the resin vessel 102, while in other embodiments the skid 110 and the resin vessel 102 may be separate, with the skid 110 being mobile and the resin vessel 102 being localized to a particular site such as a power plant.

One of the reasons the contemplated system 100 is advantageous over conventional resin cleansing technology is that it can be operated on-site using materials obtained by the site using established procurement methods and channels, a non-trivial consideration when dealing with high security and regulated locations such as nuclear power plants. According to various embodiments, the portable system 100 interfaces with on-site resources (e.g., chemicals, water, power, waste, etc.) through a plurality of conduits configured to releasably couple to said resources. These conduits comprise a first conduit 152 in fluid communication with the first pump 112 and a first chemical source 126, a second conduit 154 in fluid communication with the second pump 114 and a second chemical source 128, a water conduit 155 in fluid communication with the first pump 112, second pump 114, and a deionized water source 130, as well as a waste conduit 156 in fluid communication between the third pump 116 and a waste sump 132. As an option, these conduits may be flexible hoses 150. According to various embodiments, each conduit interfaces with the system 100 through a coupling 148 belonging to the system 100. In some embodiments, the system 100 may comprise additional connections with on-site resources (e.g., additional lines to the waste sump 132, lines to additional chemical sources, etc.).

According to some embodiments, each of these conduits may have isolation valves on each end. The conduits themselves may differ depending on the fluids they are intended to convey. As a specific example, in one embodiment, the first conduit 152 may be a chemical flex hose having a 4 inch diameter, the second conduit 154 may be an acid flex hose having a 1 inch diameter. Each of these flex hoses may be 12 feet long. According to various embodiments, the couplings 148 may be standard connectors able to interface with fittings commonly found on-site. Exemplary couplings 148 include, but are not limited to, Thor fittings (e.g., 1 inch Thor fitting, etc.), and Cam-lock fittings (e.g., 4 inch Cam-lock fittings in 316 stainless steel, etc.). Those skilled in the art will recognize that the conduits may be adapted for use with any coupling 148 known in the art.

According to various embodiments, the portable system 100 may interface with on-site resources having standardized forms. For example, in some embodiments, the first chemical source 126 may be a chemical tote 144. In the context of the present description and the claims that follow, a chemical tote 144 is a liquid container designed to facilitate the storage and transport of liquids, including caustic liquids. Examples include the widely used IBC (Intermediate Bulk Containers) totes or caged tanks, or any other similar container known in the art. In some embodiments, the second chemical source 128 may be a fifty-five gallon drum 146. The conduits may be configured to interface with chemical totes, fifty-five gallon drums, and/or other containers or liquid sources (e.g., deionized water source 130) expected to be found on-site. Additional on-site resources include power (e.g., 480V power, etc.).

The ability to interface with standard containers is advantageous for a number of reasons. One use case for the contemplated portable system is the cleansing of ion exchange resins 104 used in nuclear power plants. Transporting liquids, particularly caustic or hazardous liquids, into such a plant raises a number of logistical hurdles such as security at the plant as well as the DOT safety requirements for transporting hazardous material. These plants have established methods for procuring materials that have been approved, from sources and in quantities that satisfy the many security and safety requirements such as control room habitability, and the like. According to various embodiments, the plant may obtain beforehand the component chemicals. The containers may be coupled to the portable system 100 when it arrives on-site for the on-site cleaning of the resins 104. The ability to integrate with industry-standard containers such as 55-gallon drums 146 or chemical totes 144 facilitates the use of the portable system 100 across various industries.

While much of the discussion of the contemplated portable system 100 is done with respect to the cleansing of ion exchange resins 104, it should be noted that such a cleansing is followed by a regeneration of the ion exchange resin 104. Post-cleaning regenerations are required to reactivate ion exchange sites on resin surfaces. In some embodiments, the regeneration process may be performed using a pre-existing, on-site system, while in other embodiments, the portable system 100 may comprise, or may simply be in fluid communication with, the required regeneration materials including, but not limited to, sulfuric acid (i.e., for regenerating cation resins), sodium hydroxide and/or ammonium hydroxide (i.e., for regenerating anion resins), and other materials known in the art.

A simple pump could be used to transfer a prepared sulfite solution into the resin vessel 102 or onto a selective ion exchange membrane (e.g., reverse osmosis membrane, etc.) to restore ion exchange kinetics. However, the efficiency of the cleansing, in both time and material costs, can be greatly reduced by adding certain system parameter monitoring instrumentation. As shown, the system 100 may comprise a first instrument bank 118 and a second instrument bank 122. In the context of the present description and the claims that follow, an instrument bank is one or more sensors able to observe one or more characteristics of a fluid to which it is being exposed. The characteristics an instrument bank may observe include, but are not limited to, pH, temperature, oxidation-reduction potential (ORP), conductivity, turbidity, pressure, and the like. In some embodiments, the instrument banks are communicatively coupled to a PLC 158 or similar device that is able to receive the readings from the instrument banks and control other aspects of the system in response to the observations made. The first instrument bank 118 is in fluid communication with the mixing tank 106 and is able to observe the characteristics of the fluid 120 inside the mixing tank 106 in a first reading. The second instrument bank 122 is in fluid communication with the third pump 116, and is able to observe the characteristics of the output 124 of the third pump 116 in a second reading.

According to various embodiments, the portable system 100 may comprise additional sensors and observation devices. For example, in one embodiment, the mixing tank 106 may comprise a level meter. A level meter on the mixing tank 106 may be used to automatically shut off the third pump 116 when transferring fluid 120 to the resin vessel 102, stopping the flow before the third pump 116 loses priming. In some embodiments where the resin vessel 102 is coupled to the portable skid 110, the resin vessel 102 may also comprise a level meter.

According to various embodiments, other instrumentation that may be used within the portable system includes level monitoring instrumentation, data recorders, touch screens or other interfaces, and the like. Some embodiments may comprise devices for visually monitoring aspects of the system 100. For example, cameras (not shown) may be used to monitor and record levels and visual characteristics of fluids 120 within the mixing tank 106, resin vessel 102, and other elements, as seen through sight glasses and/or other windows. Other aspects such as valve positions, power connections, chemical mixing stations, chemical sources, conduits, waste interfaces, and the like may also be monitored with cameras. This monitoring may be done remotely, in some embodiments.

As shown, in some embodiments, the portable system 100 comprises a programmable logic controller (PLC) 158 that is coupled to the skid 110 and communicatively coupled to (i.e., able to control) the first pump 112, the second pump 114, and the third pump 116. In the context of the present description and the claims that follow, a PLC 158 is referring to any computing device capable of controlling various electrical elements of the contemplated system (e.g., pumps, valves, instrument banks, etc.) in accordance with an established program or following a set of established rules. It should be noted that while the PLC 158 could be an industrial computer that is ruggedized, highly reliable, and adapted for controlling industrial or manufacturing processes (as is known in the art), in some embodiments the PLC 158 of the portable system 100 may be any other type of computer or microprocessor capable of being programmed.

According to various embodiments, the PLC 158 is coupled to the skid 110. In some embodiments, the PLC 158 may comprise a network interface 162 (e.g., hardware configured to allow interaction with a network such as the Internet, etc.), permitting remote operation or management of the portable system 100. In still other embodiments the PLC 158, or the device controlling the operation of the system, may be remote to the system, receiving readings from the instrument banks and sending instructions to pumps and valves through a simple (e.g., simply relays instructions to the right device) controller with a network interface 162 that is on board the skid 110.

Instrumentation such as the instrument banks and other sensors, when coupled to a PLC 158 also coupled to valves 160, pumps, and flow totalizers, allows the composition of solutions made in the mixing tank 106 to be controlled within very close tolerances required for cleaning and removing ion exchange inhibitors from the surface of water treatment media. Parameters such as pH, conductivity, ORP, temperature, pressure, and solution flows, allow precise control of time and cleaning chemical volumes needed to restore surfaces of water treatment to like-new condition.

According to various embodiments, the PLC 158 may be configured to carry out all, or portions, of the contemplated method automatically. For example, in some embodiments, the PLC 158 may be configured such that, after the various conduits have been attached to on-site resources and the resin 104 is in the resin vessel 102, the PLC 158 may automatically perform operations that include, but are not limited to, a startup process (e.g., flushing pipes, pumps, tanks, and conduits with deionized water), creating and maintaining a nitrogen blanket within the mixing tank 106, recording readings from the instrument banks, creating and mixing the cleaning solution 108, injecting the cleaning solution 108 into the resin vessel 102, removing solution from the resin vessel 102, and a shutdown process (e.g., draining the system to waste, flushing with deionized water, parking the instrument banks, etc.).

In some embodiments, the PLC 158 may be programmed to automatically create and mix the cleaning solution 108. In other embodiments, the PLC 158 may be configured to automatically perform stages of the creation of the cleaning solution 108. These stages include, but are not limited to, adding a sulfite solution (i.e., first chemical 140) to the mixing tank 106, adding an acid (i.e., second chemical 142) to the mixing tank 106, adding deionized water to the mixing tank 106, and the like.

In some embodiments, the PLC 158 may be communicatively coupled to a human-machine interface (HMI), where an operator may manually configure various operations and procedure including, but not limited to, any of the functions discussed above. In some embodiments, the HMI may be used to enter the specifics for a particular cleaning run (e.g., concentration of chemicals, amount of resin 104 being cleaned, amount and/or concentration of cleaning solution 108 to create, etc.).

The system 100 also comprises piping to connect the various elements of the system, as well as valves for controlling the flows. According to various embodiments, the piping may be composed of materials able to withstand the fluids used in the contemplated methods. These materials include chlorinated polyvinyl chloride, 316 stainless steel, and the like. The valves may be ball valves, or other valves known in the art. According to various embodiments, some or all of the valves may be electrically controllable valves 160, which may be communicatively coupled to a PLC 158.

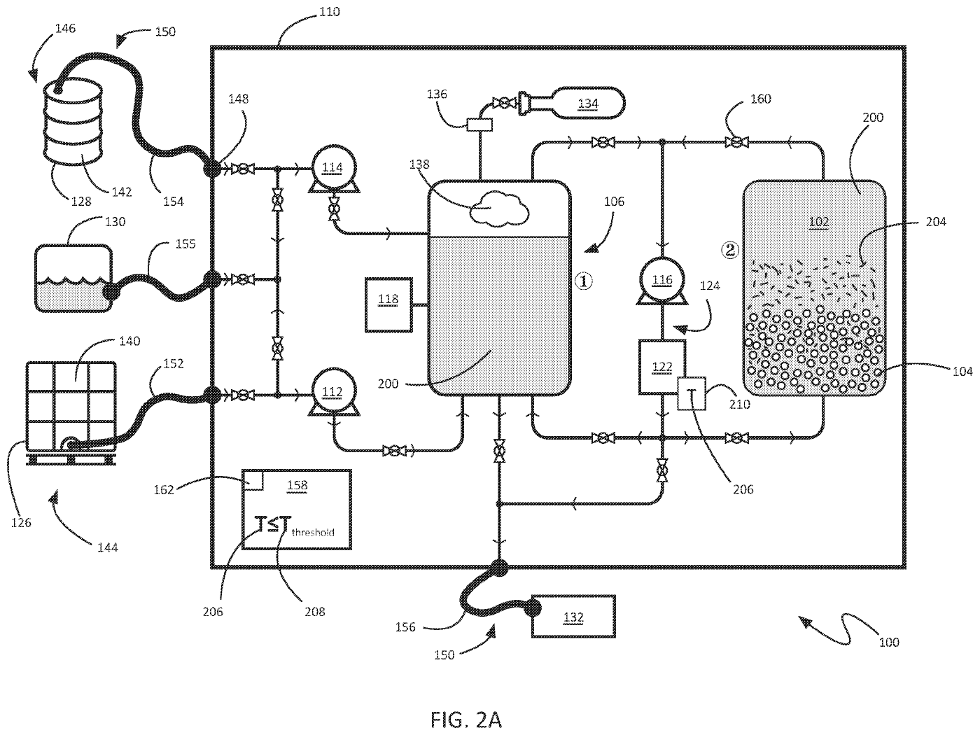

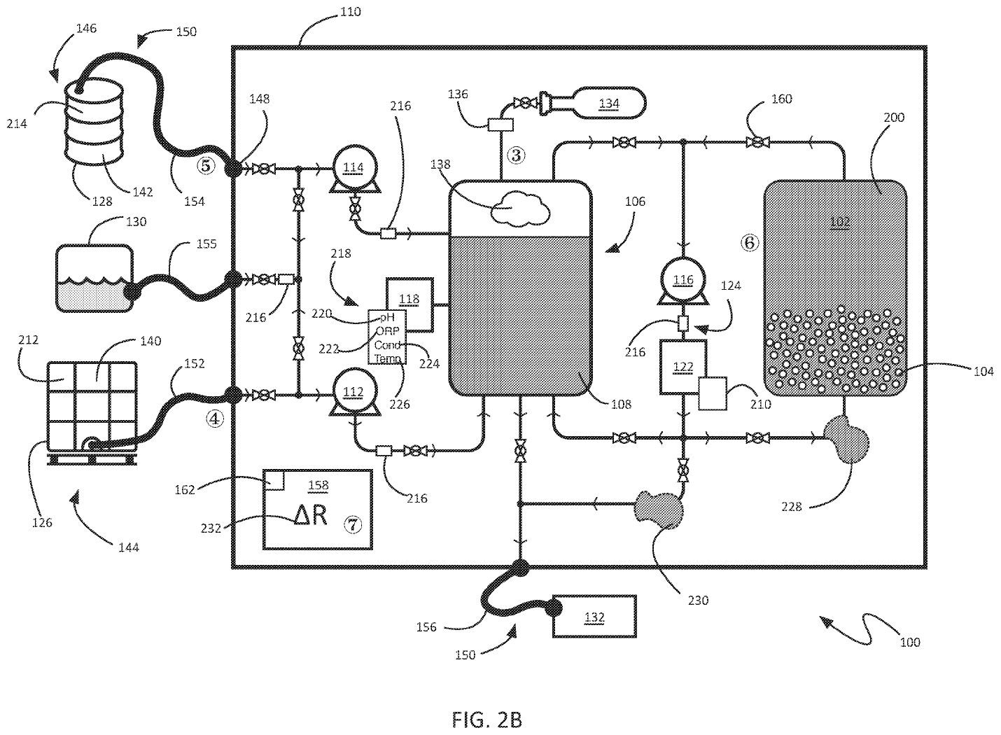

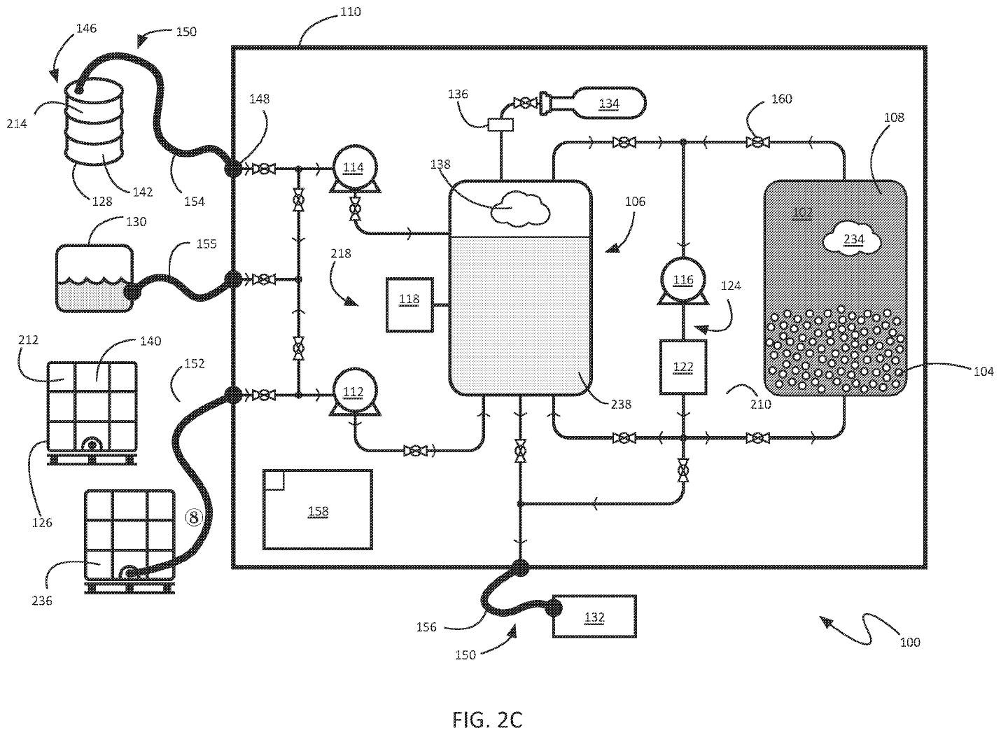

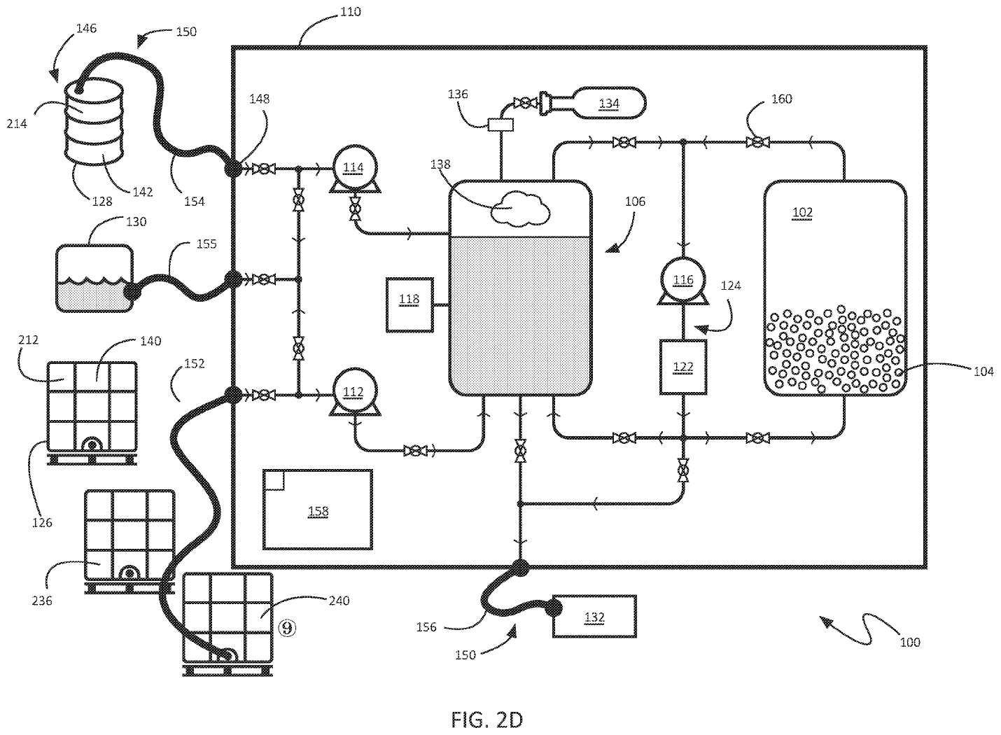

As previously mentioned, FIG. 1A shows a non-limiting example of a portable system 100 where the resin vessel 102 is coupled to the portable skid 110. While FIGS. 2A through 2D illustrate various stages of the cleaning and restoration of kinetic properties of an ion exchange resin 104 using such a portable system 100, the following is an abbreviated overview of the process. The system 100, here including a resin vessel 102 that is also mounted on the skid 110, is transported on-site. The resin 104 is then transferred into the resin vessel 102. After the system 100 has been connected to the various on-site resources such as chemicals and deionized water, the system is filled and vented with DI water. A fresh batch of cleaning solution 108 is mixed and staged in the mixing tank 106, with a nitrogen blanket 138 in place to avoid inadvertent interaction with oxygen before the cleaning is performed.

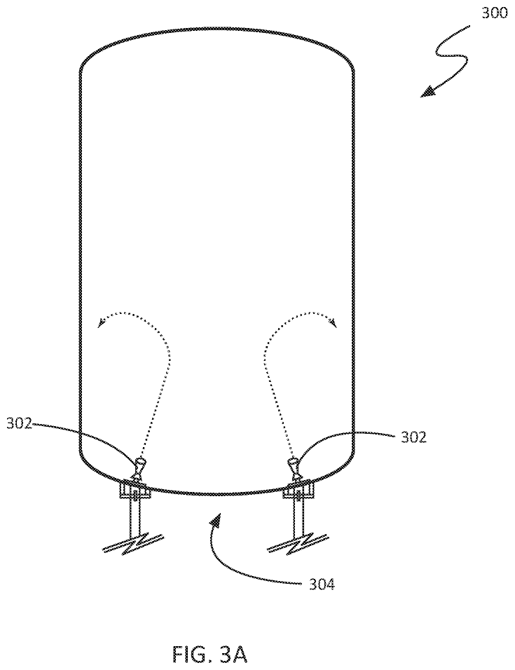

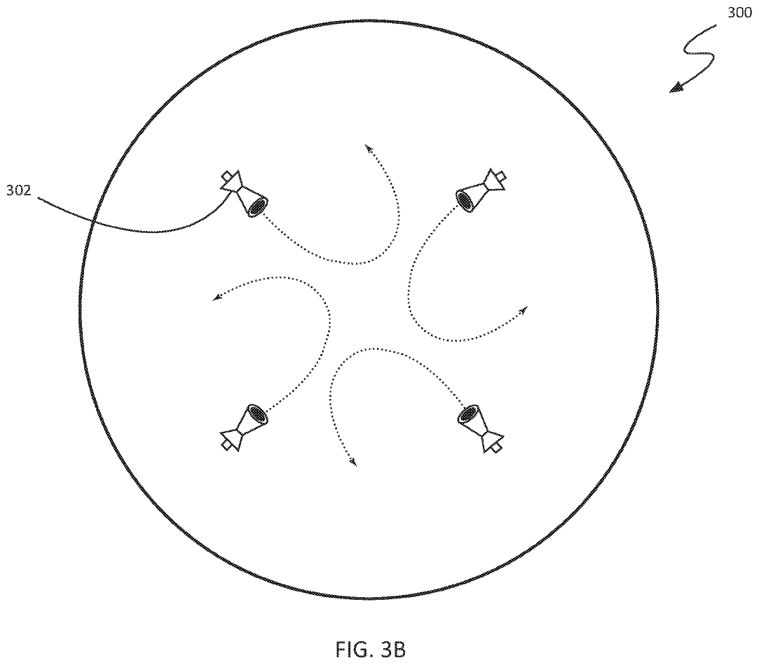

The resin vessel 102 is filled with DI water, enough to cover the fouled resin 104, and the cleaning solution 108 is introduced. One of the advantages of using a resin vessel 102 that is mounted on the skid 110 rather than cleaning the resin 104 in-place is that the resin vessel 102 may be designed with features that facilitate the cleaning process, features that wouldn't be found in typical resin containers that are used for water filtration. Various resin vessel 102 designs will be discussed in greater detail with respect to FIGS. 3-5, below.

Another advantage of using a resin vessel 102 specific to the system 100 and mounted on the skid 110 rather than cleaning in-place is that typical resin holders are not configured for recirculation. According to various embodiments, the cleaning solution 108 is recirculated in the resin vessel 102 until the readings show a depletion in the solution, which is slowly replaced with fresh solution 108 taken from the mixing vessel 106.

According to various embodiments, exposure of the ion exchange resin 104 to the cleaning solution 108 within the resin vessel 102 may be enhanced through the use of one or more eductors configured to move the ion exchange resin 104 within the cleaning solution 108. The role of eductors, and their use both inside and outside the resin vessel 102, will be discussed in greater detail with respect to FIGS. 3-5, below.

FIGS. 1B and 1C are schematic views of non-limiting examples of embodiments of the contemplated system, where the resin 104 is cleaned in-place, in a resin vessel 102 that is not part of the system and is not coupled to the portable skid 110 is it is in FIG. 1A. Specifically, FIG. 1B shows a non-limiting example of a portable system 168 where the cleaning solution 108 prepared and staged in the mixing tank 106 is injected directly into the site's resin vessel 102, after which it is sent directly to the on-site waste sump 132 after the resin has soaked for a period of time. FIG. 1C, shows a non-limiting example of a portable system 170 where the cleaning solution 108 prepared and staged in the mixing tank 106 is injected directly into the site's resin vessel 102, where it is recirculated through the vessel 102 (similar to what is done in the system 100 shown in FIG. 1A and discussed above). Each will be discussed in turn.

As shown in FIG. 1B, in some embodiments where the resin vessel 102 is on-site and located away from the portable skid 110, the system 168 further comprises a third conduit 164 placing the third pump 116 in fluid communication with the resin vessel 102. The third conduit 164, like the first conduit 152 and second conduit 154, is releasably coupled to the system 168 and the on-site infrastructure.

According to various embodiments, when the creation and mixing of the cleaning solution 108 is complete, it is pumped from the mixing tank 106 (e.g., from the bottom of the mixing tank 106, etc.) into the bottom of the on-site resin vessel 102 until it covers the resin charge 104. The resin 104 then soaks for a period of time. As a specific example, in one embodiment the resin 104 soaks for a minimum of one hour.

In some embodiments, the recirculation/transfer pump (i.e., third pump 116) is stopped when the solution 108 within the mixing tank 106 reaches a “Low-Level” point, ensuring that the third pump 116 doesn't run dry or introduce air that would have to be purged and the pump 116 re-primed. Additionally, by stopping while the third pump 116 is still primed, there is a more predictable volume on which to base future calculations. While soaking, the next batch of cleaning solution 108 may begin mixing, in some embodiments.

According to various embodiments, when the soak period has expired, the on-site resin vessel 102 is drained of the depleted cleaning solution 108 into the waste sump 132, and the process is repeated with additional chemical injections, until the waste streams indicate no iron/debris remains. As an option, in some embodiments, the portable skid 110 may comprise the instrumentation to quantitatively examine the waste stream to make such a determination.

Depending on the condition of the resin 104, resin cleaning may sometimes consist of three batches of cleaning solution 108 injected to remove all foreign materials from the resins 104. According to various embodiments, samples may be obtained during the drain down of the resin vessel 102 to waste. Forensic analyses are performed to determine turbidity, iron content, sulfite content, pH, and conductivity of waste streams of all three rounds of cleaning, according to some embodiments.

FIG. 1C, shows a non-limiting example of a portable system 170 where the cleaning solution 108 prepared and staged in the mixing tank 106 is injected directly into the site's resin vessel 102, where it is recirculated through the vessel 102 (similar to what is done in the system 100 shown in FIG. 1A and discussed above). As shown, the system 170 is connected to the on-site resin vessel 102 through the third conduit 164 and a fourth conduit 166, both of which are in fluid communication with the third pump 116.

In some embodiments, the portable system 170 may be connected to the on-site resin vessel 102 such that the cleaning solution 108 may be circulated between the mixing tank 106 and the resin vessel 102 using the third pump 116, rather than being applied in batches with soaks that are on the order of one or more hours. This recirculation is advantageous, as it provides a better endpoint, making it possible to know when the cleaning is done, even if that occurs mid-batch. This saves both time and resources.

Conventional power plants typically do not have the ability to send fluid from the resin vessel 102 back out to where it is injected. However, making such a modification to the plant (e.g., replacing an elbow with a T, etc.) may be justifiable, in light of the potential time and resource savings. Such a recirculation method may be easier to adapt for the cleaning of reverse osmosis banks, which have much lower flow and typically already have the appropriate fittings.

FIGS. 2A-2D are schematic views of various stages of the contemplated method for cleaning and restoring kinetic properties of ion exchange resins, implemented in a portable system 100 having a resin vessel 102 coupled to the portable skid 110, as discussed with respect to FIG. 1A above. It should be noted that the following discussion will focus on various stages of a specific but non-limiting example of the contemplated process, but other embodiments will be discussed as well. It is also important to note that while the following discussion will focus on applying the contemplated system 100 and method to clean anion resin 104, it may also be applied to cation resin, and a mixture of the two (except for the regeneration stage, which is specific to the type of resin, as known in the art).

FIG. 2A shows a schematic view of the startup and debris removal stages. After the portable system 100 has been moved into place and various conduits have been used to couple the system 100 to various on-site resources, as discussed above, the system 100 is filled and vented using deionized (DI) water 200. See ‘circle 1’. In some embodiments, the mixing tank 106 and resin vessel 102 are left partially filled with DI water 200. In the specific example, the mixing tank 106 may be left 20% full of DI water, while the resin vessel 102 may be left 30% full.

Next, the resin 104 is transferred to the resin vessel 102, which is then filled entirely with DI water 200. According to various embodiments, DI water 200 is circulated through the resin 102 as a rough scrubbing phase, removing debris 204. See ‘circle 2’. Getting rid of this “low hanging fruit” allows the cleaning solution 108 to focus on the more stubborn materials in later stages. In some embodiments, the resin vessel 102 may comprise a strainer or some sort of grid that assists in knocking the debris 204 loose.

The DI water 200 and suspended debris 204 is pumped out of the resin vessel 102 to the waste sump 132 by the third pump 116, such that it passes the second instrument bank 122. This is done while fresh DI water 200 is introduced to the resin vessel 102 to replace the water that was drained. According to various embodiments, this process continues until the second reading 210 from the second instrument bank 122, which comprises the turbidity 206 of the output 124 of the third pump 116, is less than a turbidity threshold 208. In some embodiments, this determination may be made automatically by the PLC 158. In the specific example, the turbidity threshold 208 may be less than 1.0 Nephelometric Turbidity Units (NTU). In other embodiments, a different turbidity threshold 208 may be used.

FIG. 2B shows a schematic view of the cleaning stage. According to various embodiments, the cleaning solution 108 is created in the mixing tank 106 by combining the first chemical 140 with the second chemical 142. As discussed above, in some embodiments, the first chemical 140 is a sulfite solution 212, and the second chemical 142 is an acid 214. Combining the component chemicals in the mixing tank 106, rather than introducing them directly to the resin vessel 102, allows for a greater degree of control of the concentrations, and facilitates the reduction of wasted time and solution.

First, however, nitrogen 138 (or other inert gas) is introduced to the mixing tank 106 to displace the oxygen 202 from the mixing tank 106. See ‘circle 3’. A nitrogen blanket 138 is used to prevent ambient oxygen 202 from coming in contact with the sulfite solution 212 (e.g., ammonium sulfite, etc.). Contact with oxygen 202 converts the sulfite to sulfate, rendering it ineffective in iron dissolution. The formation of the nitrogen blanket 138 allows the system 100 to deliver the cleaning solution 108 to the resin vessel 102 without an oxidation reaction prior to contact with metal oxides. According to various embodiments, the nitrogen blanket 138 may be purged to the on-site waste sump 132, as well as pressure during the chemical fill process. In some embodiments, the formation of the nitrogen blanket 138 may be performed automatically by the PLC 158. Those skilled in the art will recognize that there may be other methods for preventing inadvertent contact between the sulfite solution 212 and oxygen 202.

With the nitrogen blanket 138 in place, the sulfite solution 212 is injected into the mixing tank 106 using the first pump 112. See ‘circle 4’. As shown in FIG. 2B, in some embodiments, a flow totalizer 216 may be used to closely monitor the amount of solution 212 is actually being added to the mixing tank 106, permitting a greater degree of control over the concentration. As a specific example, 150 gallons of SO3 solution at ˜45% concentration may be added to the mixing tank 106, ultimately resulting in a 7% SO3 solution. In some embodiments, the sulfite solution 212 may be a 7% ammonium bisulfate, which has been shown to dissolve iron oxides and deconstruct organic materials if catalyzed with sulfuric acid. In some embodiments, that may range as high as 10% (or higher), or as low as 5% (or lower). The concentration may be closely monitored and modified by the PLC 158, in some embodiments.

In some embodiments, the addition of the sulfite solution 212 and other materials may be performed manually, through direct control of the pumps and valves involved. In other embodiments this may be controlled by the PLC 158. For example, in one embodiment, the total required volume and concentration (e.g., wht %) of sulfite 212 and catalyst 214 solutions are entered into the PLC 158 (e.g., using an HMI, etc.). Sulfite solution 212 and acid 214 volumes are then automatically calculated for achieving the desired concentrations yielding the total desired volume of cleaning solution 108. The required amount of sulfite solution 212 may be added into the mixing tank 106 from the bottom of the tank 106 so it enters under the water level and/or nitrogen blanket, avoiding contact with oxygen 202. In some embodiments, the addition of sulfite solution 212 may be done in response to a user command given to the PLC 158. In other embodiments, the PLC 158 may perform this step automatically.

After the sulfite solution 212 has been added, the first conduit 152, first pump 112, and relevant piping are flushed with DI water 200. According to various embodiments, this flushing may be performed with the water 200 ultimately going to the mixing tank 106. In addition to cleaning the equipment and channels, this flushing also adds additional volume of liquid for heat dissipation when concentrated acid 214 is added to the mixture, which helps to avoid extreme exothermic reactions. In some embodiments, this flushing may continue until the fluid level within the mixing tank 106 is approximately 75% of the desired total volume, to preserve adequate space in the mixing tank 106 for the addition of the acid catalyst and DI water 200 for a final volume adjustment.

Next, acid 214 is injected into the mixing tank 106. See ‘circle 5’. According to various embodiments, this acid 214 may be sulfuric acid. Sulfuric acid is added to catalyze the cleaning solution 108. Sulfuric acid provides the protonation energy for the dissolution of iron oxides suspended in the resin 104 as well as those oxide materials that are attached to resin surfaces. Continuing the specific example, 13 gallons of 98% concentrated sulfuric acid may be injected through the second pump 114, ultimately resulting in 12% acid solution. In some embodiments, the concentration may go as low as 0.5%. According to various embodiments, the acid 214 is added to the mixing tank 106 while the contents of the mixing tank 106 are being recirculated by the third pump 116.

According to various embodiments, the PLC 158 (or operator) may modify the concentrations of the components, based on the initial state of the resin 104. For example, the concentrations may be lowered in the case of resin 104 that is fairly new and does not have much iron oxide or crud. This helps reduce waste. In some embodiments, including embodiments where the cleaning solution 108 is injected into an on-site vessel 102 and allowed to soak (e.g., see FIG. 1B), the concentrations may be modified during the cleaning process, based on feedback from the previous cleansing cycle (e.g., soaking cycle, etc.). As an option, this may be done programmatically, using the PLC 158.

Again, after the acid 214 has been added, the second conduit 154, second pump 114, and associated piping are flushed with DI water 200. According to various embodiments, this flushing may be performed with the water 200 ultimately going to the mixing tank 106. The flushing removes any residual acid 214. In some embodiments, this flushing may continue, topping off the cleaning solution 108 until the fluid level within the mixing tank 106 is 100% full. Continuing the specific, non-limiting example, the cleaning solution 108 may be a total of 600 gallons, 447 of which is DI water, resulting in 7% SO3 solution and 12% acid solution.

Once the proper amount of chemicals have been added to the mixing tank 106, the contents are mixed until the solution 108 is a homogenous mixture. In some embodiments, this is done by comparing the first reading 218 from the first instrument bank 118 (i.e., a reading describing the fluid inside the mixing tank 106) with the second reading 210 from the second instrument bank 122 (i.e., a reading describing the fluidic output or discharge of the third pump 116). In some embodiments, this may comprise a comparison of pH 220, ORP 222, temperature 226, and/or conductivity 224. In some embodiments, the cleaning solution 108 may be recirculated for a predefined amount of time to ensure a homogenous mixture, making use of the first reading 218 from the first instrument bank 118 to mark a baseline measurement of one or more properties, to compare against readings taken by the second instrument bank 122 while the resin being cleansed (e.g., to observe the gradual depletion of the cleaning capacity of the solution 108, etc.). In still other embodiment, the recirculation/mixing may proceed until manually halted by an operator.

According to various embodiments, the solution is mixed by recirculating the liquid from an upper suction line, through the third pump 116, and back to the bottom of mixing tank 106. In other embodiments, the location of the entrance and exit with respect to the mixing tank 106 may be different. The PLC 158 automatically terminates the recirculation when the readings from the two instrument banks are substantially equal.

Once the cleaning solution 108 has been sufficiently mixed, the system 100 is ready to begin cleaning the resin 104. According to various embodiments, the cleaning solution 108 is introduced to the resin vessel 102 (which is, at this point, entirely filled with DI water 200) by displacing the DI water 200 inside the vessel 102. This continues until all of the DI water 200 has been displaced. In some embodiments, this determination may be made by the PLC 158 using information obtained from the instrument banks. For example, in one embodiment, the transfer of cleaning solution 108 to the resin vessel 102 is terminated when the conductivity 224 of the liquid being pulled from the vessel 102 (and sent to waste) is roughly equal to the conductivity 224 of the cleaning solution 108 inside the mixing tank 106 (e.g., the conductivity 224 measured by the first instrument bank 118). According to various embodiments, the cleaning solution 108 is being added fast enough to the resin vessel 102 and displacing the DI water 200 that changes in conductivity 224 or other properties due to the cleaning solution 108 reacting with the resin 104 and its contaminants is outpaced by the changes due to the quickly changing concentration within the resin vessel 102 as the DI water 200 is displaced. In other embodiments, the displacement of the DI water 200 may simply be estimated based on the known volume of DI water 200 present in the resin vessel 102 at the start of the process.

According to various embodiments, once the resin vessel 102 is full of cleaning solution 108, the cleaning solution 108 is recirculated within the vessel 102, allowing the reduction reaction to proceed, cleaning the resin 104. See ‘circle 6’. The recirculation of cleaning solution 108 is performed by the third pump 116, drawing fluid 120 out of the vessel 102 and sending it back in. As will be discussed with respect to FIG. 3, in some embodiments that flow passes through eductors that propel the resin 104 through the solution 108.

While the cleaning solution 108 is recirculating within the system 100, the sulfite is being consumed as it reacts with the metals and other contaminants degrading the resin 104. According to various embodiments, during recirculation the instrument banks are continually being compared. Specifically, the first reading 218 of the first instrument bank 118 (i.e., the contents of the mixing tank 106) is being continually compared with the second reading 210 of the second instrument bank 122 (i.e., the output of the third pump 116). See ‘circle 7’. When a difference 232 between the readings coming from these two locations is detected by the PLC 158, it triggers the addition of a small amount of fresh cleaning solution 108 from the mixing tank 106 to the resin vessel 102.

Specifically, in some embodiments, when the conductivity 224 and the oxidation-reduction potential (ORP) 222 of the first reading 218 and the second reading 210 differs, a small amount 228 of depleted cleaning solution 108 is discharged to waste from the resin vessel as an equal amount 230 of fresh cleaning solution 108 is introduced to the vessel 102 from the mixing tank 106. In some embodiments, the amount of fluid discharged/introduced may be based on the magnitude of the difference 232 between the two readings (i.e., the bigger the delta the larger the amount), while in other embodiments the amount of fluid may be fixed. As an option, in one embodiment, the amount released/replaced may be based on an amount resulting from a desired flow rate over the interval between measurements and comparisons.

The recirculation of the cleaning solution 108 and replacement of depleted solution 108 continues until it is determined that the resin 104 is sufficiently clean, or if the mixing tank 106 reaches a threshold level beyond which nitrogen may be introduced to the pipes and/or the third pump 116 may lose its prime. According to various embodiments, the PLC 158 may trigger the preparation of additional cleaning solution 108 in the mixing tank 106 if the level in the tank 106 gets too low before it is determined that the resin 104 is sufficiently clean.

According to various embodiments, the determination of whether the resin 104 is sufficiently clean may be made using the difference 232 between the first reading 218 (i.e., coming from the first instrument bank 118) and the second reading 210 (i.e., coming from the second instrument bank 122). When the PLC 158 observes that there is no substantial difference 232 between these two readings, specifically the ORP and/or conductivity of the two readings, that means the fresh cleaning solution 108 in the mixing tank 106 is the same as the cleaning solution 108 recirculating through the resin vessel 102. This means that no further chemical work is being done by the cleaning solution 108, and the resin 104 is sufficiently clean, according to various embodiments.

Once the resin 104 is clean, the cleaning solution 108 can be disposed of in the waste sump 132. However, SO2 gas is generated when mixing the catalyst (i.e., sulfuric acid) with sulfite solution. In order to avoid ambient release of SO2 gas near the waste sumps 132, it must be neutralized prior to discharge. FIG. 2C shows a schematic view of the system 100 during a gas neutralization stage.

It should be noted that, according to various embodiments, the neutralization of the SO2 gas 234 requires the introduction of a fourth chemical 236. In some embodiments, the system 100 may comprise the capacity to be simultaneously in fluidic communication with multiple chemical sources beyond the first 126 and second 128. For example, in one embodiment, the system may comprise additional conduits, couplings, and even additional pumps. In other embodiments, the fourth chemical 236, and any other needed chemicals that are compatible with the materials being used, may be pulled into the system 100 through the first conduit 152 after it has been decoupled from the first chemical source 126 and releasably coupled to a source (e.g., chemical tote, barrel, etc.) for the fourth chemical 236. See ‘circle 8’.

According to various embodiments, sodium hydroxide may be used to neutralize the SO2 gas 234 that has eluted out of solution. DI water 200 is added to the mixing tank 106, followed by NaOH (i.e., the fourth chemical 236). This neutralizing solution 238 is then recirculated through the resin vessel 102, neutralizing the SO2 gas 234. All of this is discharged to waste, and the tank and vessel are rinsed with DI water 200.

Continuing with the specific example, in one embodiment, the mixing tank 106 is first filled 60% full of DI water 200. Then, 96 gallons of 40% NaOH is added through the first pump 112 and recirculated in the mixing tank 106 using the third pump 116, resulting in a final concentration of 16% NaOH. The remainder of the mixing tank 106 is filled with DI water 200 and the neutralizing solution 238 is recirculated and mixed. The SO2 content of the resin vessel 102 is then neutralized by introducing the neutralizing solution 238 to the resin vessel 102 through the third pump 116 at a rate of 60 gpm, displacing solution from the vessel 102 back into the mixing tank and/or to waste. This is recirculated, and then drained. The mixing tank 106 and the resin vessel 102 are filled with DI water 200, and then drained to waste.

After the resin 104 has been cleaned, it must be put through the regeneration process before it can be used. Regeneration is an integral part of using ion exchange resins 104; it is how laden ion exchange resins 104 release the material they have captured, making them ready for use once again. In some embodiments, the regeneration of the resin 104 that has just been cleaned may be performed using established procedures and infrastructure already in place on-site (e.g., using the methods and protocols used to regenerate the resin 104 as part of its normal use at a power plant, etc.). In other embodiments, the regeneration may be performed by the portable system 100 and accomplished in the resin vessel 102 on the portable skid 110, using on-site resources such as regeneration chemicals. FIG. 2D is a schematic view of a portable system 100 being used to regenerate anionic exchange resin 104 that has just been cleaned.

The particular regeneration chemicals (e.g., sulfuric acid, ammonium hydroxide, sodium hydroxide, etc.) and procedures used may be dependent on the exact nature of the ion exchange resin 104 being regenerated, as known in the art. While the following discussion will be in the context of the regeneration of freshly cleaned anion resin 104, it should be noted that cation resins may also be regenerated using the contemplated portable system 100, and that anion, cation, and a mixture of the two, may be cleansed simultaneously (though would have to be separated before regeneration).

First, the regeneration solution is mixed and staged in the mixing tank 106, similar to the cleaning solution 108. According to various embodiments, the regeneration solution is made from a third chemical 240, coming from a third chemical source. In some embodiments, the third chemical source may be coupled to the system with its own conduit, while in other embodiments, the third chemical 240 may be obtained using the first conduit 152 and the first pump 112. See ‘circle 9’. According to various embodiments, the regeneration solution is injected into the resin vessel 102 from the mixing tank 106 using the third pump 116, where it is recirculated.

According to various embodiments, the regeneration solution comprising the third chemical 240 is recirculated in the resin vessel 102, with fresh regeneration solution added from the mixing tank 106 as needed, until regeneration is complete. The depleted regeneration solution may be replaced automatically, based on readings sent to the PLC 158, similar to the replenishment of cleaning solution 108 discussed above. This process of slowly displacing spent regeneration solution using fresh regeneration solution while circulating in the resin vessel 102 continues until regeneration is complete. In one embodiment, the endpoint for the regeneration may be when the second reading 210, measuring the fluid being sent to waste by the third pump, has a conductivity 224 below a threshold (e.g., less than 1.0K μS/cm, etc.). In other embodiments, the regeneration may be performed based on fluid volumes and time. For example, in one embodiment, an amount of regeneration solution at a particular concentration is prepared and injected into the resin vessel 102, where it is known to have completely regenerated the resin 104 after a certain amount of time has elapsed.

Continuing with the specific example discussed with respect to FIGS. 2A-2C, an 8% concentration of NaOH (e.g., the third chemical 240) is blended from a chemical tote 144 containing 40% NaOH. The 8% NaOH solution is used to regenerate anion resins 104 held within the resin vessel 102. NaOH transfer lines from the tote 144 to the mixing tank 106 are flushed with DI water. Resin 104 in the resin vessel 102 is regenerated with the mixing tank 106 contents until the mixing tank 106 is empty, with all flow directed to the waste sump.

According to various embodiments, after rinsing the resin 104 down to approximately 2.0 μS/cm with DI water 200, a 0.2% ammonium hydroxide solution may be prepared in the mixing tank 106. The ammonium hydroxide is then transferred to the resin vessel 102 for rinsing any sodium residuals off the resin 104, with the fluid going to the waste sump. Resins 104 in the resin vessel 102 are then rinsed to <2.0 μS/cm (as measured by the second instrument bank 122). Diffusion displacement soaks & rinses may be conducted to achieve<0.08 μS/cm, according to various embodiments.

Finally, the freshly cleaned, regenerated, and rinsed resins 104 are returned to the customer. Afterwards, all interior tanks, piping surfaces, and conduit interiors are flushed clean prior to travel to the next site, according to various embodiments. Specifically, in some embodiments, the nitrogen blanket 138 is vented into the waste sump 132 as the mixing tank 106 is filled with DI water 200 through a pump. The vent line is purged with DI water, and the mixing tank 106 is recirculated with DI water. The water is discharged until the low-level cut-off kills the third pump 116, and the remaining fluid is drained. This process may be repeated multiple times, to ensure the system 100 is clean and purged, according to various embodiments. All liquid must be drained after the cleaning takes place to avoid freezing if the resin cleaning is being performed in freezing weather. All instrument probes, cells, and other sensitive sensors in the instrument banks (or elsewhere) are typically “parked” for travel. Some instruments may require removal and/or layup, to prevent drying or other environmental damage.

As previously discussed, various embodiments of the portable system 100 contemplated herein may be automated with a PLC 158, to varying degrees. Some, or parts, of the different stages discussed above may be performed autonomously using the PLC 158. These parts include, but are not limited to, filling and venting the system before initiating the cleaning process, calibrating the electronic sensors in the instrument banks, automatically draining and flushing the system as part of a shutdown procedure, automatic flushing and parking of delicate instruments in preparation for travel, removal of fines and other debris before introducing the cleaning solution, creation and mixing of the cleaning solution 108, monitoring the various properties of the contents of the mixing tank 106 to determine when sufficiently mixed, monitoring various properties of the contents of the resin vessel 102 compared to the contents of the mixing tank 106 to determine if additional cleaning solution 108 is needed, automatically determining that the resin is sufficiently clean by comparing the first and second readings, neutralizing gases formed when catalyzing the cleaning solution 108, adjusting resin volumes, and the like.

Some embodiments of the contemplated portable system 100 make use of an on-site resin vessel 102, utilizing the vessel that holds the resin 104 while in use. In other embodiments, the system 100 cleans the resin 104 in a resin vessel 102 that is coupled to the portable skid 110 and is always a part of the system 100. In some of these embodiments, the resin vessel 102 may be designed with features that facilitate the contemplated method, features that are otherwise not likely to be found in the resin vessel 102 that is integrated with the site (e.g., power plant, etc.). FIGS. 3-5 examine some of these features.

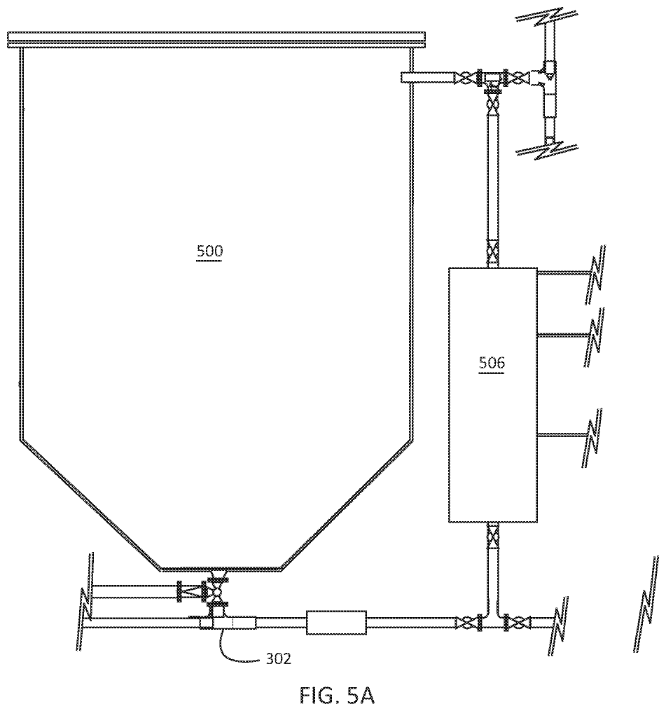

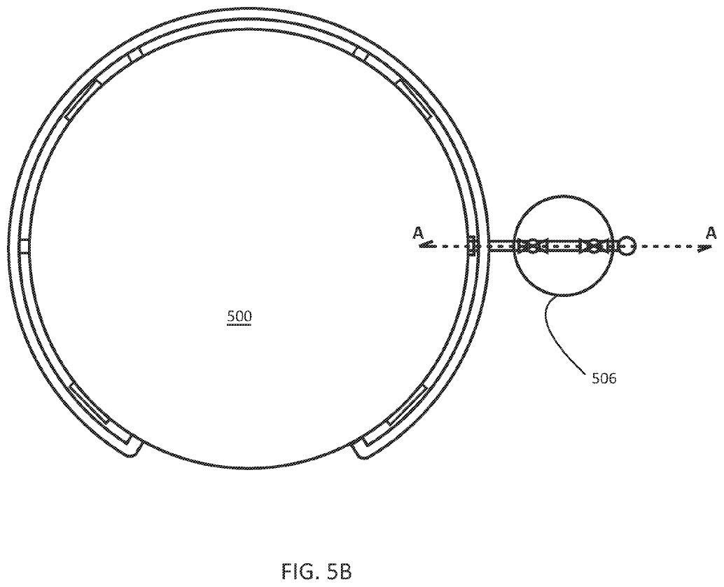

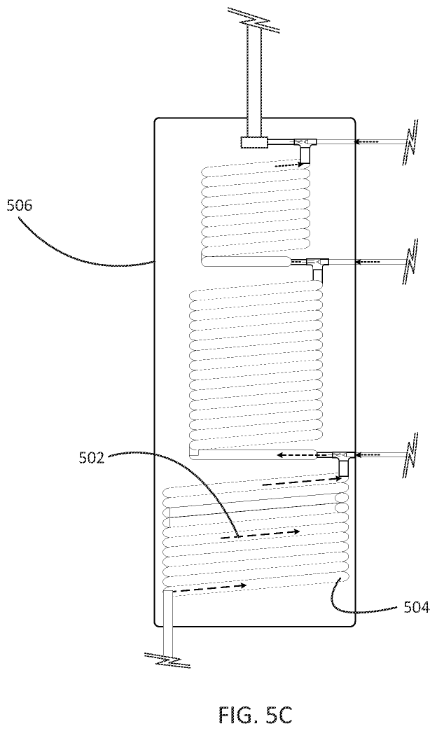

FIGS. 3A and 3B are side and top views of a non-limiting example of a resin vessel 300 having a plurality of eductors 302 on the bottom 304 of the vessel 300. These eductors 302, when provided with flowing motive fluid (e.g., cleaning solution 108 recirculated by the third pump 116, etc.), will pull resin 104 off the bottom 304 of the vessel 300 and shoot it upward, causing it to move through the cleaning solution 108, increasing its exposure and improving the efficacy and efficiency of the system 100. In some embodiments, these eductor(s) 302 may move the resin 104 along a pathway that is entirely inside the resin vessel 300. In other embodiments, such as the non-limiting example shown in FIGS. 5A-5C, eductors 302 may be used to send the resin 104 along a pathway that goes outside of the resin vessel.

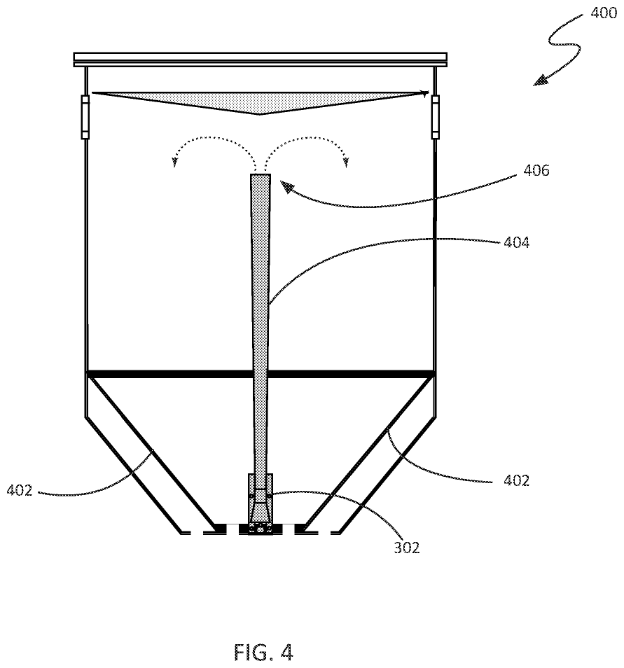

In some embodiments, these eductors 302 may propel the resin 104 without constraint other than the walls of the resin vessel 300. In other embodiments, the travel of the resin 104 within the vessel may be constrained to further enhance the exposure to the cleaning solution 108 and enhance physical interactions among the resin 104 and with the vessel itself. FIG. 4 is a side view of a non-limiting example of a resin vessel 400 having an internal plenum 404. The eductor 302 at the bottom of the vessel 400 shoots the resin 104 up through the plenum 404 and out of the top 406 of the plenum 404, to then settle back down to the bottom 304 of the vessel 400 to make the trip again.

Some embodiments of the resin vessel 102 may include structures to facilitate other stages of the cleaning process. For example, as shown in FIG. 4, the resin vessel 400 may comprise a strainer 402 through which resin 104 may be moved during the initial rinse to remove debris before introducing the cleaning solution 108.

FIGS. 5A and 5B are side and top views of a non-limiting example of a resin vessel 500 having an external scrubber module 506. FIG. 5C is a cross sectional view of the scrubber module 506 taken along A-A. In some embodiments, eductors may be used to propel the resin 104 along a pathway through a fluid that is confined to the resin vessel (e.g., resin vessel 300 of FIGS. 3A and 3B, and resin vessel 400 of FIG. 4). In other embodiments, at least one eductor 302 may propel the ion exchange resin 104 along a pathway 502 that is outside the resin vessel 500. In some embodiments, that pathway 502 may be a helical pathway 504, and the resin vessel 102 may be in fluid communication with itself through that helical pathway 504. For example, the resin 104 may travel through a scrubber module 506.

In the context of the present description and the claims that follow, a scrubber module 506 is a structure that provides a moderately tortuous circuit along which the resin 104 is propelled by one or more eductors 302, increasing exposure to the cleaning solution 108 while reducing damage caused to resins 104 by head-on collisions with each other and the walls of the system 100. According to various embodiments, the scrubber module 506 may employ a helical pathway 504 that enhances the cyclonic and centrifugal forces on the resins 104 without permitting high resin surface impact forces associated with conventional systems where the resin 104 is able to gain momentum sufficient to damage the resin 104 and produce fines.

In some embodiments, including the non-limiting example shown in FIGS. 5A and 5B, the scrubber module 506 may be external to the resin vessel 500. In other embodiments, a scrubber module 506 or similar structure may be located within the boundaries of the resin vessel 500.

Where the above examples, embodiments and implementations reference examples, it should be understood by those of ordinary skill in the art that other embodiments of systems and methods for on-site cleaning and restoration of kinetic properties of ion exchange resins could be intermixed or substituted with those provided. In places where the description above refers to particular embodiments of systems and methods for on-site cleaning and restoration of kinetic properties of ion exchange resins, it should be readily apparent that a number of modifications may be made without departing from the spirit thereof and that these embodiments and implementations may be applied to other systems and methods as well. Accordingly, the disclosed subject matter is intended to embrace all such alterations, modifications and variations that fall within the spirit and scope of the disclosure and the knowledge of one of ordinary skill in the art.

1-37. (canceled)

38. A portable system for on-site cleaning of an ion exchange resin, comprising:
a mixing tank in fluid communication with:
a first chemical source through a first pump,
a second chemical source through a second pump,
a deionized water source through at least one of the first pump and the second pump,
a nitrogen source, and
a waste sump;
a first instrument bank in fluid communication with the mixing tank, the first instrument bank configured to provide a first reading describing a fluid inside the mixing tank;
a third pump in fluidic communication with a resin vessel containing the ion exchange resin, the third pump coupled to the mixing tank such that the mixing tank is in fluidic communication with itself through the third pump and the mixing tank is in fluidic communication with the resin vessel through the third pump;
a second instrument bank in fluid communication with the third pump, the second instrument bank configured to provide a second reading describing an output of the third pump; and
a portable skid coupled to the mixing tank, the first pump, the second pump, the third pump, the first instrument bank, and the second instrument bank;
wherein a cleaning solution is made within the mixing tank by displacing oxygen from the mixing tank by filling the mixing tank with at least one of nitrogen from the nitrogen source and deionized water from the deionized water source, and injecting a first chemical, a second chemical, and deionized water into the mixing tank, the first chemical taken from the first chemical source through a first conduit using the first pump, the second chemical taken from the second chemical source through a second conduit using the second pump, and the deionized water taken from the deionized water source by at least one of the first pump and the second pump;
wherein the third pump is configured to recirculate and mix the cleaning solution, drawing the cleaning solution from the mixing tank, past the second instrument bank, and back into the mixing tank;
wherein the third pump is also configured to inject the cleaning solution into the resin vessel containing the ion exchange resin; and
wherein the portable system is in fluid communication with the waste sump through a waste conduit releasably coupled to the waste sump.

39. The portable system of claim 38, wherein the resin vessel is located away from the portable skid, and is in fluid communication with the portable system through a third conduit releasably coupled to the third pump.

40. The portable system of claim 39:
wherein the resin vessel is also in fluid communication with the portable system through a fourth conduit releasably coupled to the third pump,
wherein the cleaning solution is recirculated within the resin vessel, being sent to the resin vessel by the third pump through the third conduit and taken from the vessel by the third pump through the fourth conduit.

41. The portable system of claim 39, wherein after the cleaning solution has operated on the ion exchange resin within the resin vessel, the cleaning solution is sent directly to the waste sump from the resin vessel.

42. The portable system of claim 38, further comprising:
a programmable logic controller (PLC) coupled to the portable skid and communicatively coupled to the first pump, the second pump, the third pump, and a plurality of controllable valves, the PLC configured to:
automatically displace oxygen from the mixing tank by filling the mixing tank with at least one of nitrogen from the nitrogen source and deionized water from the deionized water source;
automatically create the cleaning solution within the mixing tank by injecting the first chemical, the second chemical, and deionized water into the mixing tank, the first chemical taken from the first chemical source through the first conduit using the first pump, the second chemical taken from the second chemical source through the second conduit using the second pump, and the deionized water taken from the deionized water source by the first pump to flush the first chemical from the first conduit and first pump and by the second pump to flush the second chemical from the second conduit and the second pump;
automatically recirculate the cleaning solution using the third pump, drawing the cleaning solution from the mixing tank, past the second instrument bank, and back into the mixing tank until the first reading from the first instrument bank substantially equals the second reading from the second instrument bank; and
automatically inject the cleaning solution into the resin vessel containing the ion exchange resin.

43. The portable system of claim 42, further comprising the resin vessel, the resin vessel being coupled to the portable skid and in fluid communication with itself through the third pump, wherein the PLC is further configured to automatically recirculate the cleaning solution through the resin vessel with the third pump.

44. The portable system of claim 43:
wherein the resin vessel comprises a strainer;
wherein the second reading from the second instrument bank comprises a turbidity of the output of the third pump;
wherein the PLC is configured to automatically:
fill the resin vessel with deionized water; and
pump additional deionized water into the resin vessel while draining deionized water and suspended debris to the waste sump until the turbidity of the second reading is less than a turbidity threshold.

45. The portable system of claim 43:
wherein the first reading and the second reading both comprise at least one of a conductivity and an oxidation-reduction potential;
wherein the PLC is configured to automatically add an amount of cleaning solution from the mixing tank to the resin vessel while removing an equal amount of used cleaning solution from the resin vessel in response to observing a difference between the first reading and the second reading, the amount determined automatically based on the difference between the first reading and the second reading.

46. The portable system of claim 43 wherein the PLC is further configured to regenerate the ion exchange resin after removing the cleaning solution from the resin vessel, the regeneration performed using a third chemical external to the portable skid and obtained using the first pump.

47. The portable system of claim 43, wherein the PLC is configured to automatically:
create a neutralizing solution within the mixing tank by mixing a fourth chemical external to the portable skid and obtained using the first pump with deionized water obtained from the deionized water source, and
neutralize SO2 gas formed within the resin vessel by gradually replacing the cleaning solution within the resin vessel with the neutralizing solution by adding neutralizing solution while gradually draining the resin vessel to the waste sump and recirculating the cleaning solution and neutralizing solution within the resin vessel using the third pump.

48. The portable system of claim 38, further comprising the resin vessel, the resin vessel being coupled to the portable skid and in fluid communication with itself through the third pump, wherein the resin vessel comprises at least one eductor configured to move the ion exchange resin within the cleaning solution.

49. The portable system of claim 48, wherein the at least one eductor moves the ion exchange resin entirely within the resin vessel.

50. The portable system of claim 49, wherein the resin vessel comprises a bottom having a plurality of eductors.

51. (canceled)

52. The portable system of claim 48, wherein the at least one eductor propels the ion exchange resin along a pathway that is outside the resin vessel, wherein the pathway is a helical pathway, and the resin vessel is in fluid communication with itself through the helical pathway.

53. (canceled)

54. The portable system of claim 38, wherein the first chemical is a sulfite solution, and the second chemical is an acid.

55. The portable system of claim 38, wherein the portable skid is sized and shaped for transport with a vehicle.

56. The portable system of claim 38, wherein the first reading comprises a pH, an oxidation-reduction potential, a conductivity, and a temperature.

57. The portable system of claim 38, wherein the first conduit and the second conduit are both flexible hoses.

58. The portable system of claim 38, wherein each of the first pump, the second pump, and the third pump are in fluid communication with a different flow totalizer.

59. The portable system of claim 38, wherein the first chemical source is a chemical tote, wherein the first conduit is configured to interface with the chemical tote, wherein the second chemical source is a fifty-five gallon drum, and wherein the second conduit is configured to interface with the fifty-five gallon drum.

60. (canceled)
